(19) United States
(12) Patent Application Publication
(10) Pub. No.: US 2008/0222729 A1
(43) Pub. Date: Sep. 11, 2008

(54) Containment of Unknown and Polymorphic Fast Spreading Worms

(76) Inventors: Songqing Chen, Fairfax, VA (US); Xinyuan Wang, Clifton, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/042,587

(22) Filed: Mar. 5, 2008

Related U.S. Application Data
(60) Provisional application No. 60/892,914, filed on Mar. 5, 2007.

(51) Int. Cl. G06F 21/00

(52) U.S. Cl. 726/24

(57) ABSTRACT

A worm containment system comprising a host computing machine, a virtual machine running under the control of a virtual machine monitor, a worm detector, a diverter and a buffer. The host computing machine has a host operating system and host application(s). The virtual machine has a clone of the host operating system and a clone of the host application(s). The worm detector is configured to monitor the virtual machine traffic for signs of worm propagation. The splitter is configured to duplicate packets intended for the host computing machine into diverted packets and buffered packets. The diverter is configured to route the diverted packets to the virtual machine. The buffer is configured to store the buffered packets and then forward the buffered packets to the host operating system on indication from the worm detector that no worm propagation behavior was detected.

### CROSS-REFERENCE TO RELATED APPLICATIONS

This application claims the benefit of U.S. Provisional Application No. 60/892,914, filed Mar. 5, 2007, entitled “Fast Spreading Worm Containment,” which is hereby incorporated by reference in its entirety.

### BACKGROUND

The fast spreading worm is becoming one of the most serious threats to today's networked information systems. A fast spreading worm could infect hundreds of thousands of hosts within a few minutes. In order to stop a fast spreading worm, we need the capability to detect and contain worms automatically in real-time. While signature based worm detection and containment are effective in detecting and containing known worms, they are inherently ineffective against previously unknown worms and polymorphic worms. Existing traffic anomaly pattern based approaches have the potential to detect and/or contain previously unknown and polymorphic worms, but they either impose too much constraint on normal traffic or allow too much infectious worm traffic to go out to the Internet before an unknown or polymorphic worm can be detected.

Internet worm defense has been a long term problem. Both passive defending approaches and active defending approaches have been extensively studied. Passive approaches basically restrict incoming traffic, e.g., through firewalls, while active approaches restrict outgoing traffic. Compared with passive approaches, with which worm traffic still flows on the Internet, active approaches can limit worm traffic to the Internet and thus mitigate the worm traffic disturbance to the Internet. In addition, passive approaches, such as firewalls, are always vulnerable to evasion opportunities [34]. Whether an active or a passive approach is taken, the worm must be detected in the first place. The worm detection strategies currently used basically fall into the following two categories.

The first is signature based. Generating a content-based signature is a traditional approach. As the worm spreads very fast today, automatic systems have been proposed to generate worm signatures [14, 17, 31]. Since application messages may be scattered over multiple packets, fast signature extraction algorithms have been proposed in Early-Bird [30] and Autograph [14]. However, it is difficult for such an approach to detect unknown worms or fast worms that spread extremely fast and leave no time for human-mediated response. The polymorphic worms or encrypted worms further challenge its capability. Compared with Polygraph [23], Hamsa [18] is shown to be able to improve the speed, accuracy, and attack resilience of fast signature generation for zero-day polymorphic worms. It has been shown that Polygraph is vulnerable to deliberate noise injection [26]. Shield [35], instead of directly dealing with worms, generates vulnerability based filters to prevent possible vulnerability exploits. Similar to the fact that not all users are willing to patch their systems in time due to various reasons; users may not get these filters on in time. In addition, if the attack targets some vulnerability that has not been discovered before, Shield is not capable of generating such filters. A recent work [4] has focused on the automatic vulnerability signature generation with a single sample exploit, which is of much higher quality than exploit-based signatures.

Without relying on worm content, the second approach is based on the observation or analysis of network traffic. If some abnormal traffic pattern is found, the reaction system is triggered to take actions, such as blocking connections to some ports or limiting the rate of outgoing connections. Since worms scan as many vulnerable hosts as possible, Snort [28] monitors the connection rate to unique IP addresses. Because random scanning is likely to be rejected with a high probability, Bro [25] monitors the failed connection numbers while the failed connection rate is collected in work [36]. For reliable detection, traffic normalizers [11, 29] or protocol scrubbers [19] have been proposed to protect the forwarding path by eliminating potential ambiguities before the traffic is seen by the monitor. Work [37] proposes a heuristic strategy that limits the rate of connections to new hosts, e.g., to allow one new connection in a second. The system proposed in [36] targets one scan per minute of compromised hosts. More broadly, some other attack detection and signature extraction rely on the honeypots that cover dark or unused IP addresses, such as Backscatter [22], honeyd [27], honeyComb [17], and HoneyStat [8]. Any unsolicited outgoing traffic from the honeypots reveals the occurrence of attacks.

Recently, a number of works have been based on virtual machine technology to deal with various security problems, including intrusion detection [6, 10], vulnerability validation [7, 12]. Notably, work [15] has examined security issue of the virtual machine itself. While there are a number works utilizing the virtual machine technology to catch worms and study worm behavior, none leverage a virtual machine to contain the propagation of fast worms.

What is needed is a system that can detect and contain fast spreading worms in real-time while blocking virtually no normal traffic.

### BRIEF DESCRIPTION OF THE SEVERAL VIEWS OF THE DRAWINGS

FIG. 1 is a block diagram of showing the architecture and flow of control for an aspect of an embodiment of the present invention.

FIG. 2 is a table showing a trend in worm size.

FIG. 3 is a diagram showing the detection of worm propagation based on timing correlation as per an aspect of an embodiment of the present invention.

FIG. 4 is a block diagram showing an implementation of an aspect of an embodiment of the present invention.

FIG. 5 is a block diagram showing another implementation of an aspect of an embodiment of the present invention.

FIG. 6 is a block diagram showing of an aspect of an embodiment of the present invention similar to FIG. 5 where the worm detector resides on the host OS.

FIG. 7 is a block diagram showing of an aspect of an embodiment of the present invention similar to FIG. 5 where the worm detector and virtual machine reside on the host OS.

FIG. 8 is a block diagram showing of an aspect of an embodiment of the present invention similar to FIG. 5 where the splitter routes buffered packets directly to a buffer instead of through the diverter.

FIG. 9 is a flow diagram showing of an aspect of an embodiment of the present invention for containing unknown or polymorphic worms.

FIG. 10 is a table showing experimental infection and code transmission time for the Slapper worm when evaluated using an aspect of an embodiment of the present invention.

FIG. 11 is a table showing web sites used to test false positive and false negatives using an aspect of an embodiment of the present invention.

FIG. 12 is a table showing client log statistics from experiments using an aspect of an embodiment of the present invention.

FIG. 13 is a graph showing the performance of a request cache when the cache size increases using an aspect of an embodiment of the present invention.

FIG. 14 is a graph showing connection cache performance with a LRU cache replacement policy using an aspect of an embodiment of the present invention.

### DETAILED DESCRIPTION OF EMBODIMENTS

Embodiments of the present invention detect and contain fast spreading worms in real-time while blocking virtually no normal traffic. A defining characteristic of a fast spreading worm is an ability to start to infect others as soon as it successfully infects one host. The fast spreading worm (abbreviated as fast worm hereafter) is becoming one of the most serious threats to today's networked information systems that we are depending on daily. Unlike all other threats, such as virus, intrusions, and spyware, fast worms could automatically propagate themselves over the network to infect hundreds of thousands of hosts without user interactions and do great harm in a short time. For example, Slammer, whose size is only 376 bytes, has been observed to probe 4000 hosts per second on average and infected about 75,000 vulnerable hosts running Microsoft SQL in about 10 minutes [21]. Although Code Red I is slower, it doubled the infected population with 37 minutes or so and infected 360,000 Microsoft IIS servers.

What makes it challenging to defend against a fast worm is its extremely fast propagation speed. In order to defend against a fast spreading worm, a capability to effectively detect and contain the worm automatically in real-time is needed. To effectively contain a fast worm, disclosed embodiments cut off a worms' propagation link at the earliest possible time.

Existing worm containment strategies can be broadly classified into two categories: signature based and traffic pattern based. Signature based approaches [4, 14, 17, 18, 30, 31] are efficient and effective in detecting and containing known worms, but they are inherently ineffective against unknown worms and polymorphic worms [23]. Traffic pattern based approaches [25, 28, 36, 37] do not rely on the worm signature, but rather on the pattern of worm traffic. Since worm propagation does have very distinctive patterns, traffic pattern based approaches could potentially detect and contain previously unknown worms and polymorphic worms. However, traffic pattern based approaches can only detect and contain a worm after the worm has started its propagation. Existing traffic pattern based approaches (such as new connection limiting [37] or unique/failed connection number counting [25, 28]) either impose too much constraint on normal traffic or allow too much infectious worm traffic to go out. The former could greatly degrade the service quality provided by the protected machine, while the latter could lead to failure in containing fast worms, given the exponential nature of worm propagation [32].

Ideally, a worm termination system should be able to detect and contain all fast worms, whether or not they are previously unknown, whether or not they are polymorphic, and allow all the normal traffic at the same time. This requires the capability to accurately detect and contain any fast worm before it really propagates to other Internet hosts. In order to detect and contain previously unknown or polymorphic fast worms, one cannot rely on worm signatures. However, traffic pattern based approaches need to observe worm propagation traffic for some time before they can determine whether or not the outgoing traffic is worm propagation. In other words, to completely contain the propagation of any unknown worm, one may need to detect its propagation. To detect the propagation of the unknown worm, one may need to see the propagation of the worm. An issue here is how to detect the propagation of any unknown worm before it propagates to and infects other Internet hosts.

This disclosure presents embodiments of a worm termination invention (also referred herein as a WormTerminator), which can detect and contain almost all fast spreading worms in real-time while blocking virtually no normal traffic. WormTerminator detects and contains fast worms based on their defining characteristic—a fast spreading worm will start to infect other hosts as soon as it successfully infects one host. Therefore, WormTerminator could detect, at least in theory, all fast spreading worms. Unlike previous worm detection and containment approaches, WormTerminator is able to detect the propagation of previously unknown or polymorphic fast worms before they can infect any other host. This is achieved by transparently diverting all outgoing traffic to a cloned virtual machine within the same host where WormTerminator resides. To the initiator of the traffic, the virtual machine appears to be the destination. WormTerminator exploits the observation that a worm keeps exploiting the same set of vulnerabilities as coded when infecting a new host. Therefore, if a worm has successfully infected the current host, it will successfully infect, after being diverted to, the virtual machine that has the exactly same vulnerabilities as the current host. Once the fast worm infects the virtual machine, the virtual machine will exhibit worm behaviors and start to infect other hosts. By monitoring the traffic pattern of the virtual machine for a specified period of time, WormTerminator is able to determine whether or not the diverted traffic is fast worm traffic without risking infecting other hosts. If the diverted traffic does not exhibit worm propagation behaviors, it will be forwarded to its real destination. In this case, the virtual machine acts as a transparent proxy between the traffic source and its original destination.

To prove the concept of WormTerminator, embodiments have been implemented in Linux and have examined its effectiveness against real Internet worm Linux/Slapper. Empirical results confirm that WormTerminator is able to completely contain fast worm propagation while allowing virtually all normal traffic in real-time. The major performance cost of WormTerminator is a one-time delay to the start of each outgoing normal connection for worm detection. By utilizing cache techniques, on average WormTerminator will delay no more than 6% normal outgoing traffic for such detection.

Epidemic Model of Fast Worm Propagation

Staniford et al. proposed the random constant scan (RCS) worm propagation model. Given an initial compromise rate of K, along time t, the RCS model determines that the proportion of those vulnerable machines that have been compromised (denoted as a) is

$$α = \frac{{e}^{K ( t - T )}}{1 + {e}^{K ( t - T )}} \qquad ( 1 )$$

where T is a constant of integration that fixes the time position of the incident. The RCS model has been validated by the empirical propagation data of Slammer [20] with an initial compromise rate K=6.7 per minute and T=1808.7 second.

It is easy to see that even if the compromise rate K is reduced to 0.67 per minute, the time needed to compromise the vast majority of vulnerable hosts only increases about 15 minutes. This means that the compromise rate K may need to be kept to a very low value in order to gain the time to react to the spreading of a fast worm. This is particularly challenging for those fast worms who scan with a hit-list (e.g., Warhol or flash worms [33]), which could make the compromise rate very close to the probe rate.

This indicates that simply throttling the worm probe traffic is neither effective in containing the worm nor acceptable to normal Internet applications. The dilemma here is how to block the worm traffic as much as possible while keeping the hosts open for normal network traffic. Ideally, one should be able to contain all the fast worm traffic and allow all normal traffic at the same time. The following will show that it is possible to block all the probing traffic of previously unknown, polymorphic fast worms while allowing virtually all non-worm traffic at the same time.

Design Goal and Principles: To completely contain fast worms, WormTerminator examines and restricts outgoing traffic from the very beginning, i.e., the first exploit of a fast worm should be detected and stopped.

A design goal of WormTerminator is to contain any known or unknown fast worm while allowing all non-worm traffic. In other words, to detect and stop the first exploit from any fast spreading worm without blocking any non-worm traffic. To achieve such a design goal, a virtual machine may be created that has cloned the operating system and server applications running on the host machine. This would allow the detection of almost all fast worms propagations before they can infect any other host on the Internet. In addition, the virtual machine serves as a transparent proxy to all non-worm traffic.

The virtual machine may clone the host operating system and server applications running on the host. This may be started automatically by the host when it starts. The communication between the virtual machine and the host machine as well as other hosts on the Internet may be controlled by the virtual machine monitor (VMM). In general, there are two types of VMM structures, depending on the relative positions of the VMM and the hardware [16]. Type I VMM has the VMM running on the hardware, while Type II has the VMM running on the host OS. WormTerminator can work with both types of VMM structures as long as the VMM is relatively well protected such that the infection of the host does not quickly compromise the VMM.

The principles underlying the WormTerminator design are as follows. First, a worm always exploits the same set of vulnerabilities as coded. Every worm is coded to exploit a certain set of vulnerabilities. Since the virtual machine is a clone of the host, it has the same vulnerabilities as the host. Therefore, if a worm has successfully exploited some vulnerabilities and has infected the current host, it is able to infect the virtual machine. Second, a fast worm always tries to propagate itself and infect others as soon as it has infected the current host. This propagation behavior is a defining characteristic of fast worms, which makes the worm propagation traffic very distinct from other traffic. This unique traffic pattern is how embodiments may determine if any particular traffic is worm propagation traffic.

Based on these principles, WormTerminator may do the following on outgoing traffic from the host on which it resides: (1) Transparently divert any outgoing traffic to the virtual machine for checking (worm detection); (2) Monitor the traffic pattern of the virtual machine to determine if the diverted traffic is worm propagation; (3) Forward the diverted traffic to its original destination once it is determined as non-worm traffic (The virtual machine starts to act as a transparent proxy for the original outgoing traffic); and (4) Drop any diverted traffic that has been determined to be worm propagation, take actions and report as appropriate.

By transparently diverting the outgoing traffic to the virtual machine, the embodiments are able to monitor worm propagation behavior without risking infecting other hosts on the Internet. To the sender of the outgoing traffic, the virtual machine appears as the original destination. Therefore, if a fast worm is trying to propagate from the current host, its propagation traffic will reach the virtual machine no matter what destination it was trying to reach. Upon arriving at the virtual machine, the worm traffic will soon infect the virtual machine and the virtual machine exhibits worm behaviors quickly. Therefore, the propagation of any fast worm should be detected and stopped at the virtual machine. On the other hand, normal traffic does not exhibit worm propagation behavior, thus it will be forwarded to the original destination eventually.

By examining the defining characteristics of worm propagation traffic in a carefully instrumented virtual machine, embodiments may be able to detect the propagation of fast worms at the very beginning and prevent the worm from infecting any other host on the Internet. At the same time, normal outgoing traffic is almost never blocked.

Compared with signature based worm detection and containment, WormTerminator is able to detect and completely contain previously unknown worms and polymorphic worms. Compared with existing traffic pattern based worm containment techniques, WormTerminator does not block any nonworm traffic, and completely blocks the infectious traffic from fast worms.

WormTerminator Architecture and Flow of Control

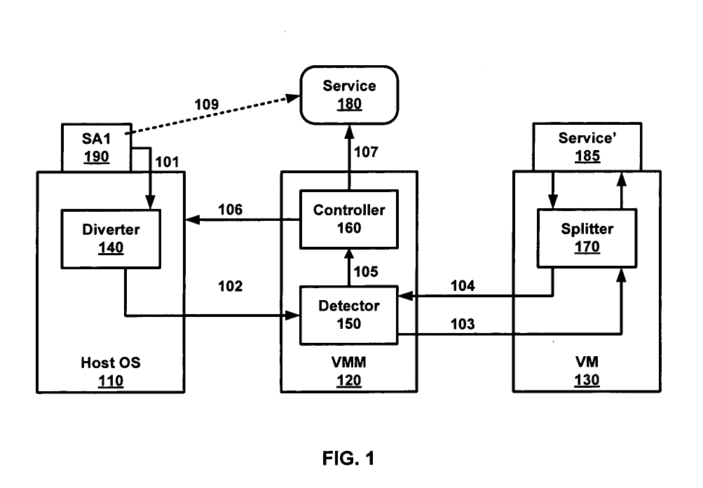

FIG. 1 shows the architecture of an embodiment of a WormTerminator and the typical flow of control for outgoing traffic. There are four major components in this embodiment: a diverter 140, a detector 150, a controller 160, and a splitter 170.

The diverter 140 may reside in the host OS 110, and may intercept any application communication 101 and send it to the virtual machine 130 through the VMM 120, pretending that the virtual machine 130 is the destination.

The detector 150 may be located in the VMM 120. Once the VMM 120 finds there is traffic 103 to the virtual machine 130, it may create the environment, by setting up the IP of the virtual machine 130 the same as the traffic destination, and opening corresponding ports if necessary. After preparation is done, the traffic 102 may be forwarded (as traffic 103) to the virtual machine 130, and the detector 150 closely watches network behaviors (as part of communications 104) of the virtual machine 130. If the forwarded traffic 103 triggers any worm-like behavior, the detector 150 may generate an alarm and report it (105) to the controller 160. Otherwise, the detector may report the forwarded traffic 103 as normal to the controller 160.

The controller 160 may logically resides in the VMM 120. Once the controller 160 receives a report from the detector 150, the controller 160 may either forward the normal traffic to its original destination or drop the worm traffic and raise an alarm to the user.

The splitter 170 may run inside the virtual machine 130 to duplicate the original request (packet). One request copy may be sent to the local service 185 for worm detection, and the other may be kept in a local buffer in case it is normal traffic and should be sent to the real destination 180.

The four components may collaborate with each other to achieve the design goal. As shown in FIG. 1, the server application SA1 190 may need to access an Internet service (indicated by the dashed line 109). However, the outgoing connection may not be established directly, as would happen in a normal host. Instead, the diverter 150 may intercept the outgoing packet 101 and divert it to the virtual machine 130 through the VMM 120. Upon receiving the outgoing packet 103, the splitter 170 at the virtual machine 130 may duplicate the request packet 103 in its buffer before forwarding the request packet to the appropriate service 185 running in the virtual machine 130. The detector 150 may monitor the network behavior of the virtual machine 130, determine whether the diverted request packet belongs to the worm propagation and reports the result to the controller 160 in the VMM 120. The controller 160 may forward any normal outgoing request packet 104 to the original destination, and drop the worm propagation packet and report to the user.

Design Issues and Solutions

Detecting worm(s): To stop the fast worm spreading, the worm should be detected at the earliest possible time. Embodiments of WormTerminator may detect worm(s) by checking if the network traffic of the virtual machine 130 has any worm propagation pattern(s). One simple criterion for detecting worm propagation pattern(s) is timing correlation between incoming and outgoing traffic. The rationales behind using the timing correlation are the following: 1) fast worms strive to propagate to and infect as many other hosts as possible in the shortest possible time; 2) fast worms are usually small in size. Therefore, the volume of worm infecting traffic should be small. After the fast worm traffic successfully infects a host, the infected host should start trying to infect other hosts in a short time. For example, it has been observed that a Linux host will start sending out infectious traffic within 10 seconds after it is infected by Linux/Slapper worm.

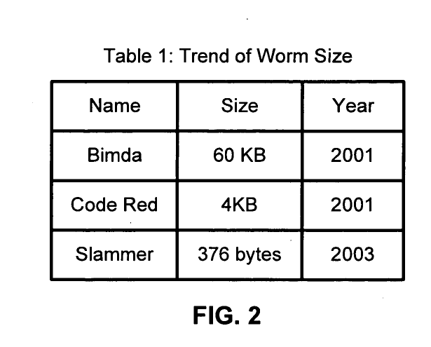

Embodiments of WormTerminator use two time thresholds for detecting the propagation of fast worms. Tₜᵢₘₑ is the maximum time interval between the time when the virtual machine 130 receives the fast worm traffic and the time when the virtual machine 130 starts to send out infectious traffic. T_{size} is the time needed to transfer the whole worm. As shown in the table in FIG. 2, worms are getting smaller. Initially, T_{size} may be set to T100 KB, the time needed to transfer 100 KB data since almost all fast worms are less than 100 KB.

To detect if any traffic diverted to the virtual machine 130 is worm traffic, the detector 150 may monitor network activities of the virtual machine 130. If the virtual machine 130 receives some continuous traffic whose transmission time is less than T_{size}, and starts to send similar traffic to other hosts within time Tₜᵢₘₑ, the diverted traffic may be considered worm traffic. Here, any traffic from the virtual machine 130 to its host machine 110 does not need to counted, and outgoing traffic from the virtual machine 130 to other hosts on the Internet may need to be considered.

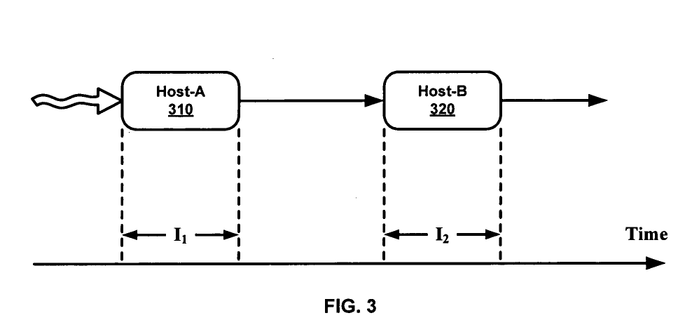

But how shall one determine Tₜᵢₘₑ? This may be important for embodiments of WormTerminator to quickly detect worms. It may also affect how long an application needs to wait for worm detection. Ideally, Tₜᵢₘₑ should be the time needed for a worm to complete its infection procedure. Clearly, different worms could take different time durations to complete such a procedure. Thus, there may not exist a fixed upper bound good for all. However, as FIG. 3 shows, if both Host-A 310 and Host-B 320 have the same set of vulnerabilities that a worm exploits, the time interval I₁, for the worm to enter Host-A 310 to the time Host-A 310 becomes a source and starts to infect others, should be close to I₂, the time interval on Host-B 320 for such a procedure, without considering the physical configuration differences between Host-A 310 and Host-B 320. In the design of embodiments of WormTerminator, Host-A 310 may be the host, while Host-B 320 may be its virtual machine 130. Thus, if one can measure I₁, they may have a good estimate of I₂ and thus set up Tₜᵢₘₑ accordingly.

Unfortunately, it may not be easy to measure I₁. The difficulty lies in that on Host-A 310, there could be several multiple concurrent inbound network flows, although the only inbound network flow interest should be the one related to the flow to Host-B 320. Since normally worms exploit the vulnerability of a running process, from there a worm process may be forked or the running process hijacked, one thus can analyze the process information to determine which incoming flow is related to a particular outgoing flow. If the worm process is forked, through tracing its parent process one may get the information about when the parent starts the last communication. This information may be used to determine when the suspicious traffic enters Host-A 310, and thus I₁. If the process is hijacked, the related information may be directly extracted from the currently running process. However, applying process tracing to determine I₁ may also need to pay attention to the following exceptions. If the outgoing traffic to the virtual machine 130 is not related to any incoming traffic to Host-A 310, e.g., it is caused by a user on Host-A 310, one may assume that under this situation, the interval, I₁, is infinity. Considering that network level activities have timing constraints from the transport level, e.g., the network connection timeout, one may also need to have a maximum threshold, MAX TIMEOUT, for the waiting time. This MAX TIMEOUT may be OS dependent.

Consider the fact that the performance of a virtual machine 130 may be slower than its original host. Denoting such slowness with a slowdown SD, one may turn I₂=SD×I₁. This leads to the final criteria, Tₜᵢₘₑ, used in embodiments of WormTerminator for worm detection if the transmission takes a time less than T_{size}:

I₂=SD×I₁,

Ttime=min(I2, MAX TIMEOUT)

How does WormTerminator distinguish worm traffic from benign traffic with wormlike traffic pattern? By definition, a fast spreading worm will start to infect others as soon as it successfully infects one host and thus may be contained by embodiments of WormTerminator. However, a few normal network applications may exhibit a similar traffic pattern as that of a fast worm, and special care may be needed to differentiate such traffic from the worm traffic.

Email Relay: To facilitate email transfer across the Internet, some SMTP servers function as relay in that they will forward the received email to the next SMTP server after adding some tracing information to the forwarded email. From an outsider's point of view, this traffic pattern is similar to worm propagation. However, a normal email relay may differ from worm propagation in three aspects. First, during the email relay, the SMTP server is not the final destination of the email. This is in contrast to the worm propagation where the infected host who is trying to infect others was indeed the destination of the infectious traffic that infected it. Second, normal email relay requires very little processing and it usually does not trigger noticeable system wide actions. On the other hand, when a worm infects a host, it usually triggers noticeable system actions such creating a new process, reading or writing files, opening a new socket. Third, SMTP relay traffic uses port 25 while most fast spreading worms use other port numbers. Therefore, normal email relay traffic can be effectively differentiated from fast worm traffic. When a worm is propagated through email, it targets the email destination rather than the email relay hosts. In this case, embodiments of WormTerminator could detect and contain the fast worm at the destination host of the malicious email.

P2P Search: In some P2P applications like Gnutella, users frequently flood their queries. Normally a query receiver would pass the query to its neighbors if applicable (e.g., based on TTL). If the query receiver does not have the requested document, the traffic pattern of the receiver may be similar to worm propagation. However, two features of P2P queries make them different from worm propagation. First, the size of P2P query is normally of tens of bytes while an unfragmented worm packet is unlikely to be less than 100 bytes. Second, a P2P query receiver only passes the query to its neighbors. In P2P networks, the neighbor information may be stored on the receiver when these neighbors joins the system, and such information is kept updated through some keep alive messages. Thus it may be possible to distinguish P2P query flooding traffic by checking the packet size and keeping track of IP addresses of recent communications.

P2P Downloading: Besides queries in P2P applications, some P2P downloading also exhibits a similar traffic pattern to that of worm propagation. For example, in BitTorrent-like systems, after a peer finishes downloading a file piece, it may simultaneously upload the file piece to several other peers. This traffic pattern is similar to that of worm propagation. The fundamental difference between the P2P downloading and worm traffic is that P2P downloading traffic normally follows a request-response model while worm traffic is almost always un-solicited. Therefore, one can differentiate the P2P downloading traffic from worm propagation traffic by checking if the current host is communicating with a host that has recently contacted the current host.

How do embodiments of WormTerminator reduce the impact to normal applications? In embodiments of WormTerminator, in principle, outgoing traffic is diverted to the virtual machine 130 for checking (unless they are the applications mentioned above with a worm-like traffic pattern that are handled separately), which inevitably affects the original applications. Such impacts are in two folds. The first is transparency. That is, such traffic diversion may be made as transparent as possible to applications running on the host 110. The second is the performance. That is, the delay for worm detection to normal applications should be minimized. Discussion of solutions to deal with them in detail follows.

In terms of application transparency, while many applications (e.g., a browser) have built-in support for proxy, one may not directly use it for diverting outgoing traffic. This is because the proxy is not the termination point, but a relay point. Since a worm is designed to infect the targeted host via an exploit on a particular application, it may not infect any proxy who merely relays the traffic to its ultimate destination. Therefore, one may have to make sure the outgoing traffic terminates at the virtual machine 130 in order to let any worm traffic be able to infect the virtual machine 130. To achieve this, one can either change the destination IP address of the outgoing traffic to that of the virtual machine 130 or dynamically set the IP address of the virtual machine 130 to be the destination IP address of the outgoing traffic. Given that the outgoing traffic may have some built-in integrity check on the IP header (i.e. IPsec AH header), changing the destination IP address of outgoing traffic may not always feasible. Therefore, dynamically setting the IP address of the virtual machine 130 may be a better way to deceive worm traffic.

After setting the IP address of the virtual machine 130 to be the destination IP address of the outgoing traffic, the virtual machine 130 appears to be the destination of the outgoing traffic. After the diverted traffic terminates at the virtual machine 130, the detector may decide whether the diverted traffic is worm traffic by monitoring the virtual machine's 130 network activities for a specified period of time. If the diverted traffic is worm traffic, it may be blocked. Otherwise, it may need to be relayed to the real destination. For connectionless traffic such as UDP, one may simply forward the packets (saved by the splitter 170) from the virtual machine 130 to its destination. For connection oriented traffic such as TCP, state information may be maintained at both sides of the communicating parties. To the sender on the host machine 110, the virtual machine 130 is the destination. In this case, one may not simply forward the TCP packet to its destination. Instead, the virtual machine 130 may need to reestablish a connection to the destination and start to function as a relay or proxy between the sender in the host machine 110 and the receiver on the real destination. The packets saved by the splitter 170 may be used for generating appropriate application level requests to be sent to the destination. In this sense, the virtual machine 130 functions as an application aware proxy.

While operation of embodiments WormTerminator may be made as transparent as possible to most applications on the host machine 110, there may be some extra overhead introduced by embodiments of WormTerminator. To be specific, outgoing connections may be delayed when they are diverted to the virtual machine 130 for checking. Several ways are possible to reduce the overall performance impact.

First, if some configurable number of UDP packets from some flow have passed checking, one may directly route the rest UDP packets of the same flow without diverting them to the virtual machine 130. This may decrease the average performance overhead of some embodiments of WormTerminator.

Another way to improve the performance of embodiments of WormTerminator is to use a cache to store such examined connections, and associate an expiration time with each cache entry. (This cache can be combined with the cache used to address the worm-like benign traffic). Before the expiration time, packets of recently examined connection may not be diverted to the virtual machine 130, but routed to its destination directly. For those connections that are not in the cache or have expired, the first configurable number of packets may be diverted to the virtual machine 130 for checking. If they pass the checking, the connection may be put into the cache with an expiration time. Since normally client accesses show great temporal localities and spatial localities, this caching strategy may amortize the worm detection overhead over multiple repetitive connections.

These performance improvements represent some tradeoff between security and performance. Depending on the performance and security requirements, users of embodiments of WormTerminator may choose to 1) divert all outgoing traffic to the virtual machine 130 for checking; or 2) cache individual connection and only divert those packets that are not part of cached connections; or 3) cache all connections to a particular destination to which some connection has recently passed checking.

On the other hand, there is also a technology trend to put multiple, and possibly multithreaded, processor cores onto a single processor chip so as to fully utilize the available transistors and to tolerate very long memory latency. Most desktop/server processors today have more two processors cores; for example, Intel Pentium D and Core Duo 2, AMD Athlon Dual-core, IBM Power4 and Power5 [13], among many others. An extreme example is the Sun Niagara processor [24], which has eight 64-bit UltraSparc cores and each core can execute up to four threads, supporting 32 threads in total. Not all the time the applications may be able to fully utilize those cores and hardware thread contexts. On those processors, embodiments of WormTerminator may be able to utilize idle cores or thread contexts, increasing the processor utilization and having less impact on the performance of the host system.

Implementation

To prove the concept of WormTerminator, a prototype was implemented. To test with the Internet worm Linux/Slapper which attacks Apache servers, HTTP/HTTPS support was implemented in the prototype. In principle, embodiments of WormTerminator could work with any application protocol if appropriate protocol support is added.

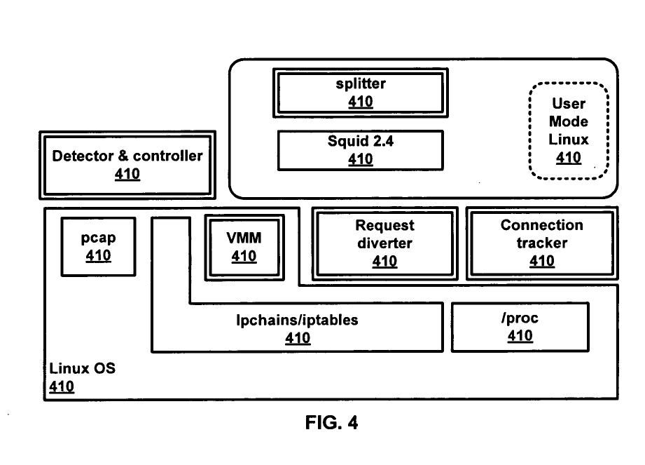

FIG. 4 shows a modularized implementation of this embodiment. Newly implemented components are shown with double outline. The host OS 410 is RedHat 7.3, running Linux kernel 2.4.18. The virtual machine is User-Mode-Linux 420 [9]. As implied by the name, User-Mode-Linux 420 itself runs as an application process in the host OS. The disk storage for User-Mode Linux 420 is contained entirely inside a single file on the host machine, called the root file system for User-Mode-Linux 420. It provides several approaches to supporting virtual machine communications with the host physical machine and the world outside.

As shown in this FIG. 4, there are four major parts to this embodiment implementation, a connection tracker 430, a request diverter 440, a splitter 450, and a detector 460. The connection tracker 430 is configured to trace the incoming and outgoing connection flows to and from the host. A purpose of such a component is to determine I₁ and thus set up I₁. It is implemented as a kernel module on the /proc 470 filesystem of the host machine. The request diverter 440 is configured to capture and divert client requests to User-Mode-Linux 420. It is implemented as a kernel module hooked to ipchains/iptables 472 on the host machine. The splitter 450 is configured to duplicate and stores application level requests from the traffic diverted to the virtual machine. It is implemented based on Squid 2.4 480 STABLE1 (with cache function disabled) and runs inside of User-Mode-Linux 420. The detector and controller 460 are implemented in one daemon to monitor the traffic and make the examination decision with the help of the pcap library 474, ipchains/iptables 472, and the VMM 476. A host TUN/TAP device is used for User-Mode-Linux communications [9].

This prototype implementation was also ported to Fedoral Core 2 with kernel 2.6.5. More protocol support may be added to the Linux prototype, and embodiments of WormTerminator should also be implementable on Windows platforms.

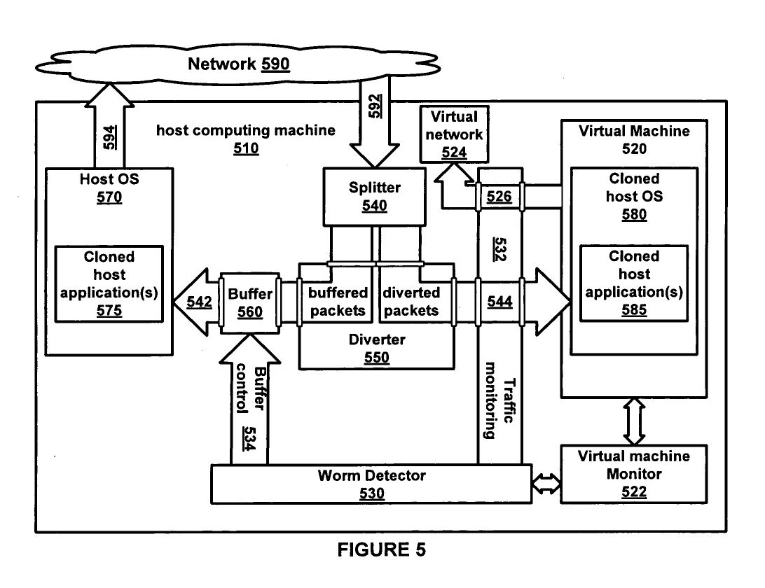

FIG. 5 is a block diagram showing another implementation of an aspect of an embodiment of the present worm containment invention. As illustrated this embodiment includes a host computing machine 510, a virtual machine 520, a worm detector 530, a splitter 540, a diverter 550, and a buffer 560. As illustrated in this example embodiment, the host computing machine 510 has a host operating system 570 configured to manage host application(s) 575. The host application(s) 575 may include just about any type of application including web browsers, word processors, databases, or the like. The virtual machine 520 may run under the control of a virtual machine monitor 522 and may include: a clone of the host operating system 580; and a clone of the host application(s) 585.

Worm detector 530 is configured to monitor the virtual machine traffic (532) for signs of worm propagation behavior. Worm propagation behavior may include attempts to infect other hosts and may be characterized using metrics such as propagation speed and number of intended targets. Many different actions may be taken when the worm detector 530 detects worm propagation behavior such as reporting the detected worm propagation behavior, isolating the related diverted traffic, resetting the state of the virtual machine, suspending the virtual machine, or the like.

Splitter 540 may be configured to duplicate incoming packets 592 from network 590 intended for the host computing machine 510 into: diverted packets 544 and buffered packets 560. Diverter 550 may be configured to route the diverted packets 544 to virtual machine 520. Buffer 560 may be configured to: store the buffered packets 542 and forward the buffered packets 542 to the host operating system 570 on indication from the worm detector 530 that no worm propagation behavior was detected by the traffic monitor 532.

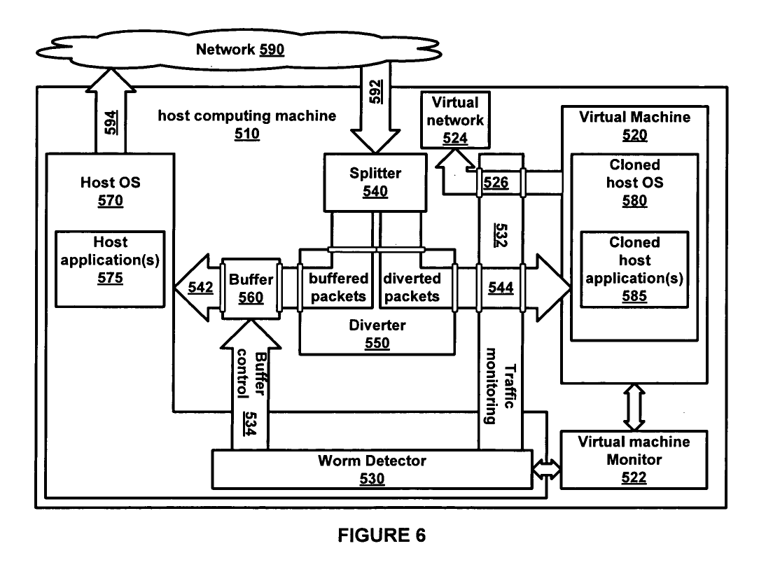

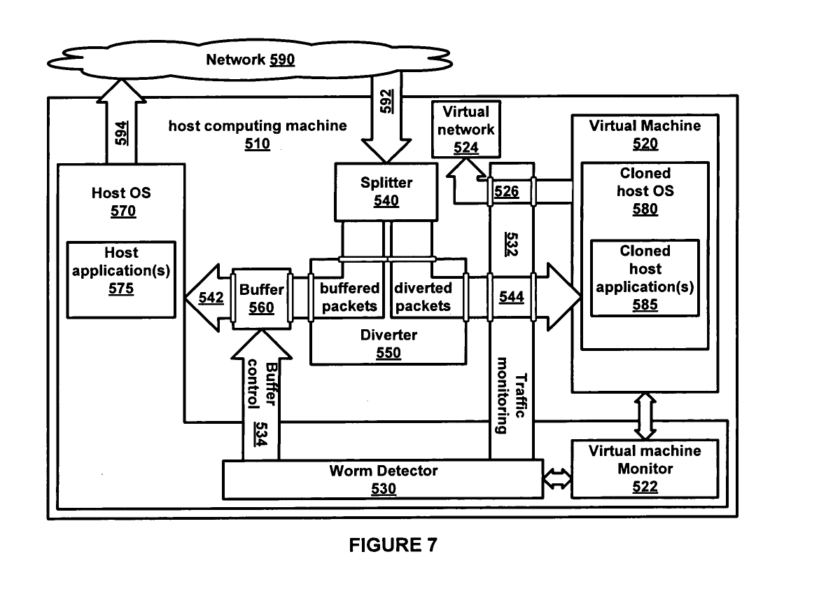

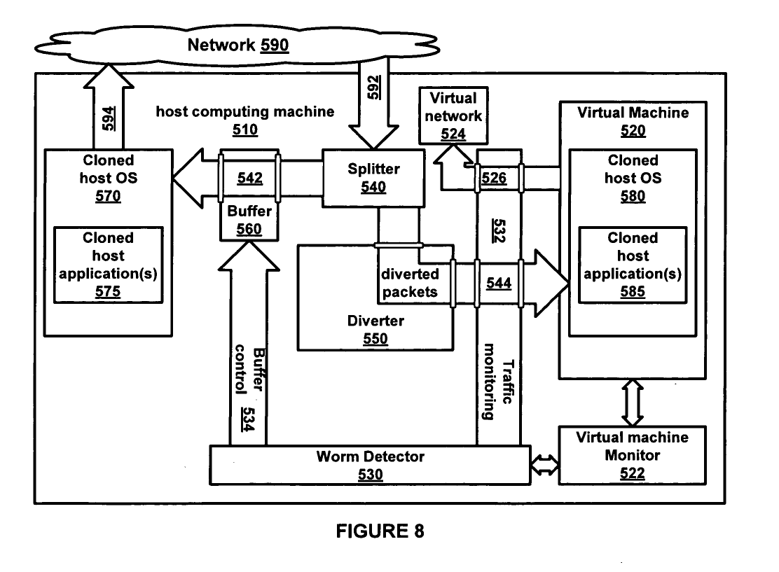

The embodiment illustrated in FIG. 5 may be modified in many ways and still be within the scope of the present invention. For example, FIG. 6 is a block diagram showing of an aspect of an embodiment of the present invention similar to FIG. 5 where the worm detector resides on the host OS. FIG. 7 is a block diagram showing of an aspect of an embodiment of the present invention similar to FIG. 5 where the worm detector and virtual machine reside on the host OS. FIG. 8 is a block diagram showing of an aspect of an embodiment of the present invention similar to FIG. 5 where the splitter routes buffered packets directly to a buffer instead of through the diverter. Additionally, logical components in the invention may be combined as long as the overall functionality of the invention is maintained. For example, the splitter 540 and diverter 550 may be integrated in some embodiments. As variation such as those illustrated in FIG. 6, FIG. 7 and FIG. 8 and the like, do not functionally change the operation of the invention, it is expected that such variations are within the scope of the claimed invention.

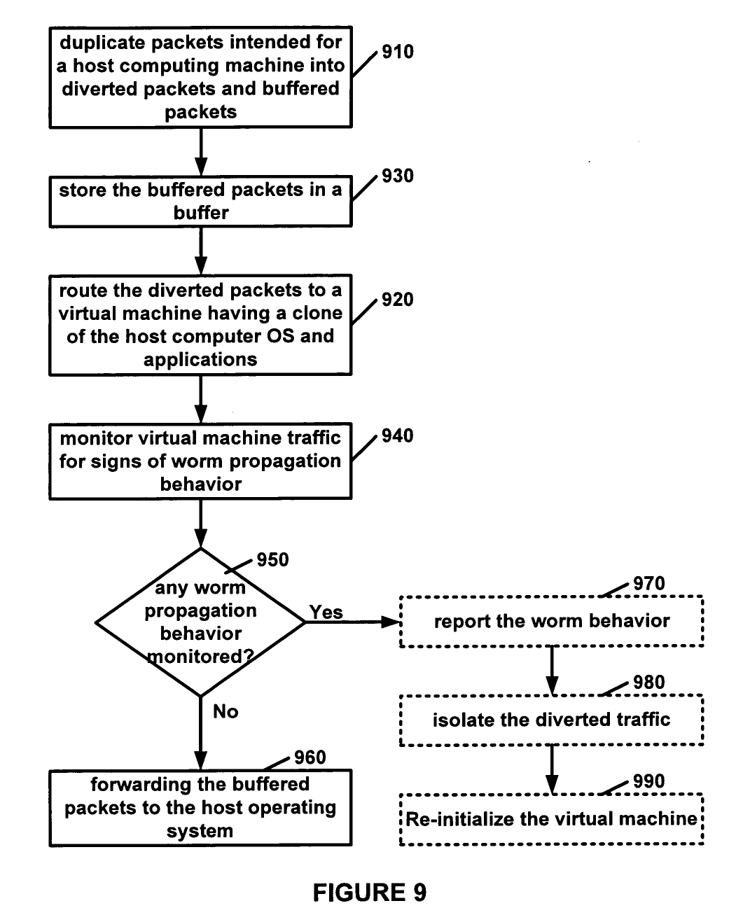

Some embodiments of the present invention may be a computer-readable media tangibly embodying a program of instructions executable by a computer to perform a method for embedding a block authentication code into stream data. FIG. 9 is a flow diagram showing actions for containing unknown or polymorphic worms as per an aspect of an embodiment of the present invention. As illustrated, packets from a network intended for a host computing machine may be duplicated to generate: diverted packets and buffered packets at 910. The host computing machine may have: a host operating system; and at least one host application. At 920, the buffered packets may be stored in a buffer. At 930, the diverted packets may be routed to a virtual machine that may be running under the control of a virtual machine monitor. The virtual machine may have a clone of a host operating system and a clone of host application(s). The virtual machine traffic may be monitored for signs of worm propagation behavior at 940. A determination as to whether worm propagation behavior was detected may be made at 950. If the determination is negative, then the buffered packets may be forwarded to the host operating system. If the determination is positive, many possible options may be executed such as: reporting the worm behavior (970); isolating the diverted traffic (980) and re-initializing the virtual machine to a known state (990).

Evaluations.

In this section, results from an empirical evaluation of embodiments of the WormTerminator invention are evaluated and analyzed to seek answers to the following questions: 1) how effective is the tested WormTerminator embodiment in containing real worm propagation traffic mingled with normal traffic? and 2) what is the impact to normal applications?

Linux/Slapper Test: Linux/Slapper [1] is a family of worms exploiting the vulnerability of an OpenSSL buffer overflow in the libssl library, which further enables Distributed Denial of Service (DDoS) attacks [3]. It is different from many existing worms since it targets the buffer overflow in the heap. Slapper targets vulnerable Apache Web server 1.3 on Linux operating systems, including RedHat, SuSe, Mandrake, Slackware, and Debian. According to Symantec DeepSight Threat Management System, more than 3500 computers were infected [2].

The basic procedure that Slapper uses is as follows. When a worm instance is active, it scans class-B networks, looking for Apache servers by attempting to connect to port 80. After determining the server is vulnerable, it tries to send the exploit code to the SSL service via port 443. Upon a successful exploit, Slapper encodes its source code (.bugtraq.c) and sends it to the victim and stores it as a hidden file (.uubugtraq) under a /tmp directory. There, it uu-decodes the file, compiles, and executes the binary, with the sender's address as an input parameter.

The exploit procedure of Slapper is more complicated than many existing fast worms. A successful exploit uses buffer overflow twice, and takes 1+20+2 requests. The first one is used to get the Apache server version information. The next 20 are used to force Apache to use up possible existing processes. Then two HTTPS requests are launched to exploit the vulnerability and inject the shell code, upload itself, compile and execute the binary.

Compared to worms that we have listed in FIG. 2, the size of Slapper (which first appeared in 2002) is also large. The original source code is 67655 bytes, and the uu-encoded source code is propagated between vulnerable hosts, which is 93461 bytes.

To test whether this worm can be successfully contained by an embodiment of WormTerminator, a test environment was setup as follows. The host ran RedHat 7.3, with Apache 1.3.23, mod ssl 2.8.6, and OpenSSL 0.9.6. The kernel was 2.4.18. User-Mode-Linux has the same configurations. The machine was running with a 2.4 GHz CPU and 1 GB physical memory.

Two other machines were set up in the same local network with the same configurations, connected through a 10/100 M hub. One acted as the Slapper original source with 127.0.0.1 as the input parameter, and the other was the trigger with the IP address of the first as the input parameter. Slight changes to the source code were made so that the worm started to exploit the network segment where the host resides without waiting to exploit other non-related network addresses first as originally coded.

For the effectiveness experiments, the MAX TIMEOUT was set as 2 minutes, default by TCP. The other important parameter was SD, which was critical depending on the performance slowdown of the virtual machine. Thoroughly studying the performance slowdown of any virtual machine was not the focus of this study. However, a previous study [16] has reported that compiling Linux 2.4.18 kernel inside UMLinux [5] takes 18 times as long as compiling it on a Linux host operating system. Considering that there is few network activities involved in kernel compiling and User-Mode-Linux is faster than UMLinux, we setup SD for our User-Mode-Linux with 18 too. In these experiments, T_{size} was T100 KB.

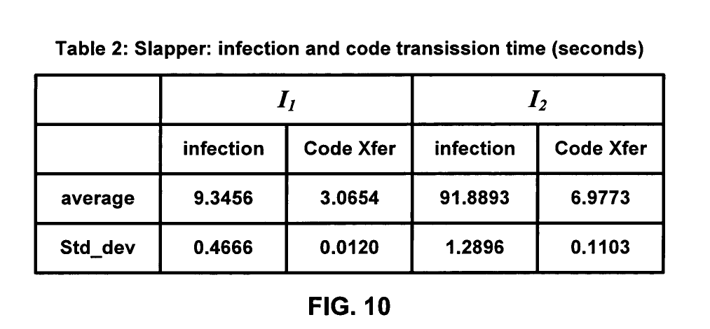

The experiments were run 10 times, and each time the WormTerminator embodiment successfully captured Slapper at the worm's first exploit. The table in FIG. 10 shows the measurement results with the average and the standard deviation. The small standard deviation indicates the consistency of measurement results. A successful infection only takes about 10 seconds between physical machines. To verify this, the worm source code was also instructed directly to get very close results. It took about 1.5 minutes to make the detection decision, which implies a slowdown of User-Mode-Linux around 10. The code transmission time differences indicated that the network transmission speed is only roughly half of the physical link. Further evaluate of this overhead is discussed in the next subsection.

From the experimental results, one can see if the performance of User-Mode-Linux is better with a smaller slow-down, the detection time could be further reduced.

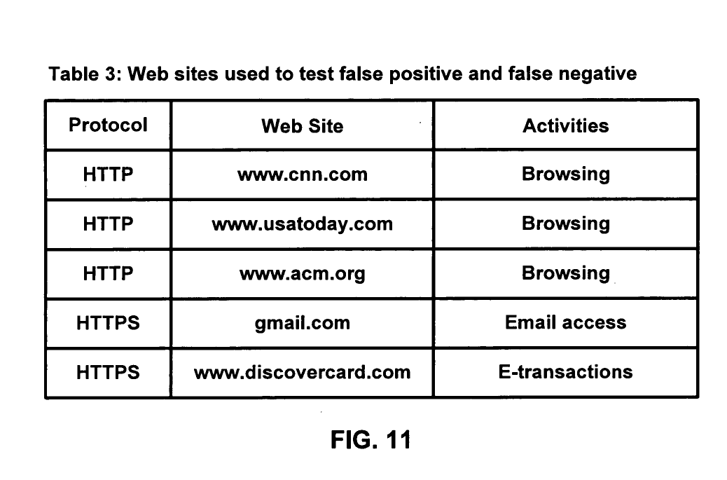

To study whether one can detect worms in a mix of traffic, i.e., false positives and false negatives, the following two sets of experiments were performed. In the first set, with a normal Mozilla browser (version 0.9.9), a few Web sites as listed in the table in FIG. 11 were accessed repetitively from the host machine to test if the WormTerminator embodiment would falsely take any traffic as worm traffic. In all the experiments, the Squid cache function was disabled. In the period of the experiments of 1 hour, no false positive were found. In the second set of experiments, while these Web sites were accessed, Slapper was activated. In all cases, the embodiment of WormTerminator successfully detected the worm traffic at its first exploit and disconnected the network.

Impact on Normal Applications: With a cache in WormTerminator embodiment, some client traffic could avoid being examined and thus do not suffer the long delay. To enable this function, the examined connections may need to be saved in the cache.

As mentioned above, there could be different levels of cache. The object for caching could be the connection (destination host and port), or could be the host alone. For HTTP/HTTPS requests, one can even cache the request.

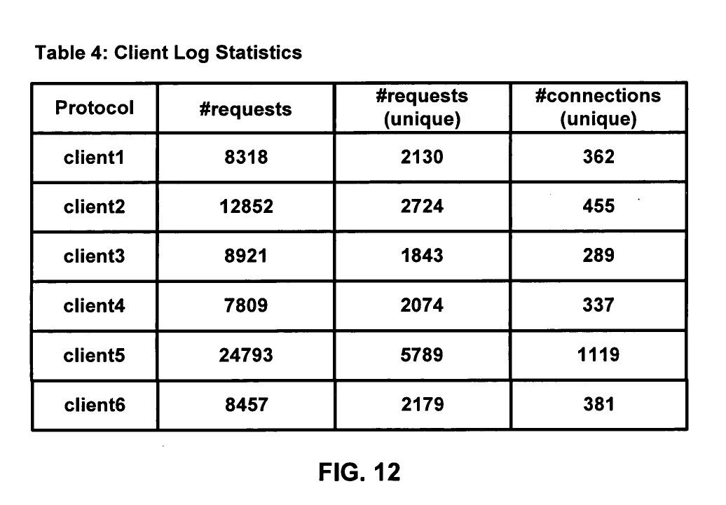

For different levels of caches, different sizes of cache space may be required. To study how many client requests would be affected with a what size of the cache, a simple simulator was run to analyze six client Web browser logs collected in a lab environment for about 4 months. The table in FIG. 12 briefly summarizes some statistics of client access logs.

First, using cache to cache client requests was considered. Following the idea of Squid, caching of one request demands a memory size of 128 bits after applying MD5 to the URL. With the field of expiration time, each request cache entry was 20 bytes. Note that in the simulations, the expiration time was not used and the replacement was purely based on LRU.

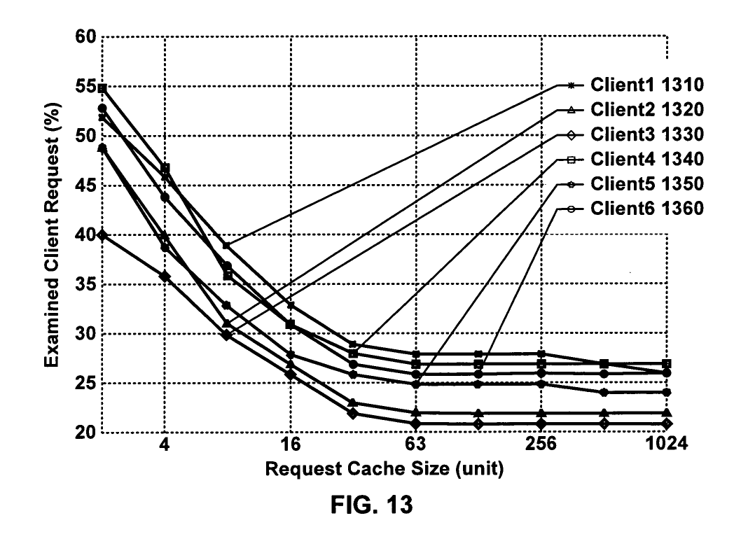

FIG. 13 shows the performance of the request cache when the cache size increases. The figure shows that when the cached objects are requests, a size of 64 cache entries (equivalent to 1.25-KB memory size) may be good enough to achieve near optimal performance. A 1.25-KB memory may be a trivial cost for modern computers. However, with a request cache, roughly 28% of requests may have to be examined, and thus suffer a long delay due to worm detection in the tested embodiment of WormTerminator.

To further decrease this ratio and improve the client performance, also considered was whether to cache the connection. One connection cache entry includes destination IP, port, and expiration time, which requires 10 bytes.

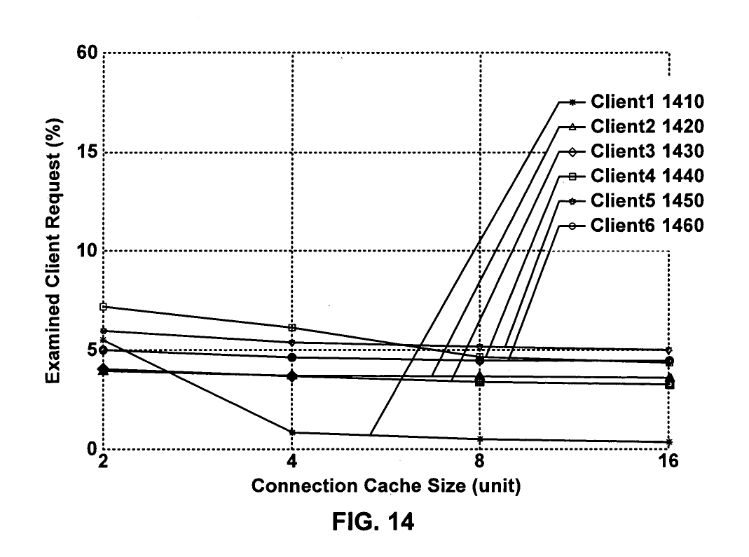

FIG. 14 shows the connection cache performance with a LRU cache replacement policy. As the figure indicates, a cache with 8 units (equivalent to 80 bytes) may be good enough to approximately achieve optimal performance. Thus, if a connection cache is used, the cost may be very trivial, and less than 6% of client requests suffer the long delay caused by the worm detection processing in tested embodiment of WormTerminator. The examination of a host cache gave similar results as the connection cache, because Web servers normally use fixed ports.

The cache performance was largely determined by client access locality. The above experiments were just case studies to demonstrate that different levels of caches can mitigate the impact of the WormTerminator embodiment on normal applications. A more sophisticated cache may apply some advanced replacement policy and consider expiration time.

Conclusion: Detecting and containing fast spreading worms in real-time are very challenging, especially for those previously unknown or polymorphic worms. A contribution of this invention is that it is indeed possible to detect and contain almost all unknown, polymorphic worms in real-time while allowing virtually all normal traffic to go out.

The disclosed worm detection and containment are based on the defining characteristic of fast worms. By leveraging the virtual machine technology, these embodiments are able to detect the propagation of any fast worm before it can infect any other host on the Internet. This would allow one to almost completely contain nearly all fast worms no matter whether they are unknown, polymorphic or not. The WormTerminator concept was validated by implementing a prototype in Linux, and have examined its effectiveness against real Internet worm Linux/Slapper. The real-time experiments confirm that the tested embodiment of WormTerminator was able to contain fast worms without blocking normal traffic.

The following references are referred to as an aid to explain and enable the presently disclosed embodiments: [1] www.symantec.com/avcenter/venc/data/linux.slapper.worm.html; [2] www.symantec.com/index.htm; [3] An analysis of the slapper worm exploit. (www.symantec.com/avcenter/reference/analysis.slapper.worm.pdf; [4] D. Brumley, J. Newsome, D. Song, H. Wang, and S. Jha. Towards automatic generation of vulnerability-based signatures. In Proceedings of IEEE Symposium on Security and Privacy, Berkeley/Oakland, Calif., May 2006; [5] K. Buchacker and V. Sieh. Framework for testing the fault-tolerance of systems including os and network aspects. In Proceeding s of the IEEE Symposium on High Assurance System Engineering (HASE), pages 95-105, October 2001; [6] P. Chen and B. Boble. When virtual is better than real. In Proceedings of the Workshop on Hot Topics in Operating Systems (HotOS), pages 133-138, May 2001; [7] M. Costa, J. Crowcroft, M. Castro, A. Rowstron, L. Zhou, L. Zhang, and P. Barham. Vigilante: End-to-end containment of internet worms. In Proceedings of SOSP, Brighton, United Kingdom, October 2005; [8] D. Dagon, X. Qin, G. Gu, W. Lee, J. Grizzard, J. Levine, and H. Owen. Honeystat: Local worm detection using honeypots. In Proceedings of RAID, 2004; [9] J. Dike. A user-mode port of the linux kernel. In Proceedings of the Linux Showcase and Conference, October 2000; [10] G. Dunlap, S. King, S. Cinar, M. Basrai, and P. Chen. Revirt: Enabling intrusion analysis through virtual-machine logging and replay. In Proceedings of the Symposium on Operating Systems Design and Implementation, pages 211-224, December 2002; [11] M. Handley, V. Paxson, and C. Kreibich. Network intrusion detection: Evasion, traffic normalization, and end-to-end protocol semantics. In Proceedings of USENIX security Symposium, August 2001; [12] A. Joshi, S. King, G. Dunlap, and P. Chen. Detecting past and present intrusion through vulnerability-specific predicates. In Proceedings of SOSP, Brighton, United Kingdom, October 2005; [13] Ron Kalla, Balaram Sinharoy, and Joel M. Tendler. IBM Power5 chip: A dual-core multithreaded processor. IEEE Micro, 24(2):40-47, March/April 2004; [14] H. Kim and B. Karp. Autograph: Toward automated distributed worm signature detection. In Proceedings of USENIX Security, San Diego, Calif., August 2004; [15] S. King, P. Chen, Y. Wang, C. Verbowski, H. Wang, and J. Lorch. Subvirt: Implementing malware with virtual machines. In Proceedings of IEEE symposium on security and privacy, Berkeley/Oakland, Calif., May 2006; [16] S. King, G. Dunlap, and P. Chen. Operating system support for virtual machines. In Proceedings of the Annual USENIX Technical Conference, June 2003; [17] C. Kreibich and J. Crowcroft. Honeycomb—creating intrusion detection signatures using honeypots. In Proceedings of HotNets, Boston, Mass., November 2003; [18] Z. Li, M. Sanghi, Y. Chen, M. Kao, and B. Chavez. Hamsa: Fast signature generation for zero-day polymorphic worms with provable attack resilience. In Proceedings of IEEE Symposium on Security and Privacy, Berkeley/Oakland, Calif., May 2006; [19] G. Malan, D. Watson, and F. Jahanian. Transport and application protocol scrubbing. In Proceedings of IEEE INFOCOM, 2001; [20] D. Moore, V. Paxson, S. Savage, C. Shannon, S. Staniford, and N. Weaver. The spread of the sapphire/slammer worm. http://www.caida.org/publications/papers/2003/sapphire/sapphire.html; [21] D. Moore, V. Paxson, S. Savage, C. Shannon, S. Staniford, and N. Weaver. Inside the slammer worm. In Proceedings of IEEE Security and Privacy, volume 1, July 2003; [22] D. Moore, C. Shannon, and Jeffery Brown. Code-red: a case study on the spread and victims of an internet worm. In Proceedings of the second Internet Measurement Workshop, November 2002; [23] J. Newsome, B. Karp, and D. Song. Polygraph: Automatically generating signatures for polymorphic worms. In Proceedings of IEEE Symposium on Security and Privacy, Oakland, Calif., May 2005; [24] K. Aingaran P. Kongetira and K. Olukotun. Niagara: A 32-way multithreaded Sparc processor. IEEE Micro, 25(2), 2005; [25] V. Paxson. Bro: a system for detecting network intruders in real time. In Computer Networks, volume 31, December 1999; [26] R. Perdisci, D. Dagon, W. Lee, P. Fogla, and M. Sharif. Misleading worm signature generators using deliberate noise injection. In Proceedings of IEEE symposium on security and privacy, Berkeley/Oakland, Calif., May 2006; [27] N. Provos. A virtual honeypot framework. Technical report, University of Michigan, October 2003; [28] M. Roesch. Snort: Lightweight intrusion detection for networks. In Proceedings of Conference on System Administration, November 1999; [29] U. Shenkar and V. Paxson. Active mapping: Resisting nids evasion without altering traffic. In Proceedings of IEEE Symposium on Security and Privacy, May 2003; [30] S. Singh, C. Estan, G. Varghese, and S. Savage. The earlybird system for real-time detection of unknown worms. Technical report, University of California, San Diego, August 2003; [31] S. Singh, C. Estan, G. Varghese, and S. Savage. Automated worm fingerprinting. In Proceedings of OSDI, San Francisco, Calif., December 2004; [32] S. Staniford. Containment of scanning worms in enterprise networks. In Journal of Computer Security, 2004; [33] S. Staniford, V. Paxson, and N. Weaver. How to Own the internet in your spare time. In Proceedings of USENIX Security, San Francisco, Calif., August 2002; [34] t. Ptacek and T. Newsham. Insertion, evasion, and denial of service: Eluding network intrusion detection. http://www.insecure.org/stf/secnet-ids/secnet-ids.html, January 1998; [35] H. Wang, C. Guo, D. Simon, and A. Zugenmaier. Shield: Vulnerability-driven network filters for preventing known vulnerability exploits. In Proceedings of ACM SIGCOMM, Portland, Oreg., August 2004; [36] N. Weaver, B. Staniford, and V. Paxson. Very fast containment of scanning worms. In Proceedings of USENIX Security, San Diego, Calif., August 2004; and [37] M. Williamnson. Throttling viruses: Restricting propagation to defeat mobile malicious code. In Proceedings of Annual Computer Security Applications Conference, Las Vegas, Nev., December 2002.

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e hardware with a biological element) or a combination thereof, all of which are behaviorally equivalent. For example, the ARCF filter may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement the ARCF filter using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of containing worms on a Linux based machines. However, one skilled in the art will recognize that embodiments of the invention could be practiced that contain worms on a widows based computing machine.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A worm containment system, comprising:
a) a host computing machine having a host operating system, the host operating system configured to manage at least one host application;
b) a virtual machine running under the control of a virtual machine monitor, the virtual machine having:
i) a clone of the host operating system; and
ii) a clone of the at least one host application;
c) a worm detector configured to monitor the virtual machine traffic for signs of worm propagation;
d) a splitter configured to duplicate packets intended for the host computing machine into:
(1) diverted packets; and
(2) buffered packets;
e) a diverter configured to route the diverted packets to the virtual machine; and
f) a buffer configured to:
i) store the buffered packets; and
ii) forward the buffered packets to the host operating system on indication from the worm detector that no worm propagation behavior was detected.

2. A worm containment system according to claim 1, wherein the virtual machine monitor runs on the host computing machine.

3. A worm containment system according to claim 1, wherein the splitter and diverter are integrated.

4. A worm containment system according to claim 1, wherein the virtual machine monitor runs on the host operating system.

5. A worm containment system according to claim 1, further including the worm detector reporting any detected worm propagation behavior.

6. A worm containment system according to claim 1, further including isolating the diverted traffic for which the worm detector detected worm propagation behavior.

7. A worm containment system according to claim 1, wherein the worm propagation behavior includes attempts to infect other hosts.

8. A worm containment system according to claim 1, wherein the virtual machine is suspended after the worm detector detects worm propagation behavior.

9. A worm containment system according to claim 1, wherein the worm propagation behavior is characterized using propagation speed and number of intended targets.

10. A worm containment system according to claim 1, wherein the virtual machine is reset to an original state after the worm detector detects worm propagation behavior.

11. A computer-readable media tangibly embodying a program of instructions executable by a computer to perform a method for containing worms on the computing machine, the method comprising:
a) duplicating packets intended for a host computing machine into: diverted packets and buffered packets, the host computing machine having a host operating system configured to manage at least one host application;
b) storing the buffered packets in a buffer;
c) routing the diverted packets to a virtual machine, the virtual machine running under the control of a virtual machine monitor, the virtual machine having:
i) a clone of a host operating system; and
ii) a clone of the at least one host application;
d) monitoring virtual machine traffic for signs of worm propagation; and
e) forwarding the buffered packets to the host computing machine when no worm propagation behavior was monitored.

12. The media as in claim 11, wherein the virtual machine monitor runs on the host computing machine.

13. The media as in claim 11, wherein the virtual machine monitor runs on the host operating system.

14. The media as in claim 11, further including reporting any detected worm propagation behavior.

15. The media as in claim 11, further including isolating the diverted traffic for which worm propagation behavior was monitored.

16. The media as in claim 11, wherein the worm propagation behavior includes attempts to infect other hosts.

17. The media as in claim 11, wherein the worm propagation behavior is characterized using propagation speed and number of intended targets.

18. The media as in claim 11, further including suspending the virtual machine after worm propagation behavior is monitored.

19. The media as in claim 11, further including resetting the virtual machine to an original state after worm propagation behavior is monitored.

20. A method for containing worms on a computing machine, the method comprising:
a) duplicating packets intended for a host computing machine into: diverted packets and buffered packets, the host computing machine having:
i) a host operating system; and
ii) at least one host application;
b) routing the diverted packets to a virtual machine, the virtual machine running under the control of a virtual machine monitor, the virtual machine having:
i) a clone of a host operating system; and
ii) a clone of the at least one host application;
c) storing the buffered packets in a buffer;
d) monitoring virtual machine traffic for signs of worm propagation; and
e) forwarding the buffered packets to the host computing machine when no worm propagation behavior was monitored.
